(19) United States
(12) Patent Application Publication
(10) Pub. No.: US 2009/0072503 A1
(43) Pub. Date: Mar. 19, 2009

(54) SYSTEM FOR CENTRIFUGAL-FORCE COMPENSATING IN AN ELECTRIC MACHINING-CHUCK ACTUATOR

(76) Inventor: Georg ROHM, Sontheim (DE)

Correspondence Address: K.F. ROSS P.C., 5683 RIVERDALE AVENUE, SUITE 203 BOX 900, BRONX, NY, 10471-0900, US

(21) Appl. No.: 12/211,878

(22) Filed: Sep. 17, 2008

(30) Foreign Application Priority Data
Sep. 17, 2007 (DE) 102007044309.0

(51) Int. Cl. B23B 31/14; B23B 31/16

(52) U.S. Cl. 279/130

(57) ABSTRACT

A chuck rotatable about an axis has an actuator system with a housing rotatable about the axis and connected to the chuck, a threaded rod in the housing, extending along the axis, connected to the jaws, and axially displceable to radially shift the jaws, an electric motor, a drive wheel rotatable about the axis on the housing and driven by the motor, and a harmonic drive. This drive has a wave generator rotationally fixed to the drive wheel, a flexspline surrounding the wave generator and having external teeth, and a ring gear fixed on the housing meshing with the ring gear, and normally rotating jointly with the threaded shaft, a threaded connection between the flexspline and the threaded rod. A sensor on the chuck detects an instantaneous rotation speed of the chuck, and a controller connected between the sensor means and the electric motor axially shifts the chuck in accordance with the sensed rotation speed.

### FIELD OF THE INVENTION

The present invention relates to a chuck actuator for a machining apparatus such as a lathe. More particularly this invention concerns a method for compensating the centrifugal force when operating a machining apparatus that has an electric clamping device or actuator, to a determination method for a correlation table for the method for compensating the centrifugal force, and to a machining apparatus that has an electric actuator and that has a centrifugal-force compensating device.

### BACKGROUND OF THE INVENTION

An electric actuator is known having a housing that may be attached to the working spindle of a chuck of the machining apparatus and in which a threaded rod is axially displaceable for displacing the jaws of the chuck, and an electric positioning motor whose rotor is connected to a drive wheel connected in turn to a wave generator of a harmonic drive whose ring gear is connected to the housing and whose flexspline has external teeth that drive a spindle nut associated with the threaded rod.

When machining workpieces using conventional machining apparatuses the problem occurs with outside gripping that as speed increases the influence of centrifugal force reduces the instantaneously acting clamping force on the workpiece because the centrifugal force, which increases as the speed increases, acts against the working pressure on the jaws. A higher speed is desired for more rapid workpiece processing so that the above-described problem becomes increasingly important with ever more demanding requirements for speed and efficiency when processing workpieces. At extremely high rotation speeds

In a conventional method for assuring adequate clamping force at higher speeds, the initial clamping force in a conventional machining apparatus is increased so much that the instantaneously acting clamping force is adequate for machining the workpieces, even at higher speeds. However, this conventional method has the disadvantage that the higher the speed is for the machining, the more the initial clamping force must be increased. The increased initial clamping force is applied both at the beginning of the clamping process prior to the speed increasing and also at the end of the clamping process when the speed on the workpieces is reduced. Thus this method has the disadvantage that workpieces made of materials that are sensitive to deformation are damaged due to the increased initial clamping force at the beginning of the clamping process and/or at the end of the clamping process.

Another conventional method for assuring adequate clamping force at higher speeds uses mechanical centrifugal force compensation. The disadvantage of an elevated initial clamping force is avoided in this manner. However, this method has the disadvantage of so-called clamping force hysteresis. When braking from a high speed, clamping force hysteresis leads to a markedly higher clamping force than at the beginning of the clamping process. Thus the method having mechanical centrifugal force compensation and the machining apparatus having mechanical centrifugal force compensation have the disadvantage that, once again, workpieces made of materials that are sensitive to deformation are damaged at the end of the clamping process.

### OBJECTS OF THE INVENTION

It is therefore an object of the present invention to provide an improved machining system for compensating out centrifugal force.

Another object is the provision of such an improved machining system for compensating out centrifugal force that overcomes the above-given disadvantages, in particular that, at high speeds.

### SUMMARY OF THE INVENTION

A chuck rotatable about an axis has according to the invention an actuator system with a housing rotatable about the axis and connected to the chuck, a threaded rod in the housing, extending along the axis, connected to the jaws, and axially displceable to radially shift the jaws, an electric motor, a drive wheel rotatable about the axis on the housing and driven by the motor, and a harmonic drive. This drive has a wave generator rotationally fixed to the drive wheel, a flexspline surrounding the wave generator and having external teeth, and a ring gear fixed on the housing meshing with the ring gear, and normally rotating jointly with the threaded shaft, a threaded connection between the flexspline and the threaded rod. A sensor on the chuck detects an instantaneous rotation speed of the chuck, and a controller connected between the sensor means and the electric motor axially shifts the chuck in accordance with the sensed rotation speed.

This has the advantage that a pre-specified effective clamping force, that is the actual clamping force applied at standstill plus or minus the clamping force added or subtracted to compensate for rotation plus or minus the clamping force increased or decreased by rotation depending on whether the tool or workpiece is externally or internally engaged by the jaws, is maintained with only minor deviations over a broad range of speeds. This is particularly advantageous for more rapid machining, especially for materials that are sensitive to deformation such as for instance bearing rings or other thin-walled workpieces that require low-deformation clamping.

With the machining apparatus, for example the effect occurs by advancing and/or retracting the threaded rod. The electric motor may be mounted adjacent the housing. In the machining apparatus, the electric motor is preferably connected to the drive wheel via a belt drive. Moreover, the externally toothed flexspline may be coupled to the spindle nut via a claw clutch. With the machining apparatus it is possible for the claw clutch to be provided with some play. The spindle nut can be a roller screw drive. Preferably a cover for the housing is provided for connecting to a frame of the machining apparatus.

At least one sensor is advantageously arranged in a jaw in the machining apparatus, the sensor being configured for measuring the effective centrifugal force-dependent clamping force. This has the advantage that the changes in the effective centrifugal force-dependent clamping force may be measured, and where necessary corrected, as a function of the speed during machining. The actual or net force applied by the jaws to the workpiece is directly related to rotation speed, increasing with rotation speed with external chucking and decreasing with internal chucking.

The method according to the invention includes the step of controlling the effect on the displacement of the jaws of the chuck, via the threaded rod, as a function of the instantaneous speed of the chuck. This method for operating the machining apparatus has the advantage that a pre-specified clamping force is maintained on the workpieces with only minor deviations over a broad range of speeds. According to the invention the method further comprises the ste of selecting from a correlation table at least one correlation value of the effect for the pre-specified speed of the chuck and then supplying the selected correlation value(s) of the effect to a controller for the machining apparatus. The use of a correlation table has the advantage that the necessary effect is determined for the specific speed in a simple and rapid manner. The correlation table may be determined for each machining apparatus individually or just once for all machining apparatuses in a model series.

In the method, the correlation table advantageously contains at least a first subtable for use when increasing the speed of the chuck and at least a second subtable for use when reducing the speed of the chuck. Thus the influences of friction, which have different influences on the centrifugal force when speeding up and when slowing down, are factored in.

In the method, the first and second subtables are preferably selected as a function of the clamping diameter and/or the material to be machined. This has the advantage that the method is optimized with respect to the required constancy of the effective centrifugal force-dependent clamping force and accelerated machining as a function of the clamping diameter and/or the material to be machined.

The method for operating the machining apparatus may be performed particularly rapidly when the correlation table has correlation values for the effect on the displacement of the jaws of the chuck, via the threaded rod, for a speed interval of 500 revolutions/minute (rpm) for a range of speeds from 0 to 10,000 rpm. In terms of uniformity of the effective centrifugal force-dependent clamping force, it is advantageous for the method for operating the machining apparatus when the speed interval for the correlation values is 100 rpm, preferably 20 rpm, and in particular 10 rpm, and the range of speeds is 0 to 8,000 rpm, preferably 0 to 5,000 rpm, and in particular 0 to 3600 rpm.

One preferred embodiment of the method for operating the machining apparatus has the step of detecting an effective centrifugal force-dependent clamping force by means of at least one sensor associated with a jaw and a method step of regulating the effect on the displacement of the jaws of the chuck, via the threaded rod, as a function of the sensor data. Thus the changes in the effective centrifugal force-dependent clamping force are measured, and where necessary corrected, as a function of the speed during machining. If it is also possible to use a correlation table, this has the advantage that the method can continue to be operated despite potential failure of the sensor.

Moreover, in the method for operating the machining apparatus, the initial value of the clamping force may be adjusted to the required clamping force increased by the regulating interval.

In an inventive determination method for a correlation table for the above-described method for operating the machining apparatus for at least one speed of the chuck a correlation value for the effect on the displacement of the jaws of the chuck, via the threaded rod, is determined such that the influence of the centrifugal force on the clamping force is reduced for this speed. Thus the effective centrifugal force-dependent clamping force is maintained over a broad range of speeds within the required constancy.

Another aspect of the invention relates to a storage medium having a correlation table that was determined according to one of the above-described determination methods. This has the advantage that for instance a new correlation table that is adapted to different materials of the workpieces or to another type of machining may be transferred in a simple manner to machining apparatuses in accordance with the invention.

One additional aspect of the present invention relates to a storage medium having a computer program for performing one of the above-described methods for operating a machining apparatus. Thus, firstly, machining apparatuses in accordance with the invention may be improved and, secondly, even conventional machining apparatuses may be retrofitted in accordance with the invention.

The present invention furthermore also relates to retrofitting conventional machining apparatuses. It is particularly advantageous that centrifugal force compensation can be attained using a controller of the effect on the displacement of the jaws of the chuck, via the threaded rod, as a function of the instantaneous speed of the chuck.

Another aspect of the present invention relates to a storage medium having a computer program for performing one of the above-described determination methods for the correlation table. This has the advantage that it is possible in a simple manner to use the determination method on different machining apparatuses.

### BRIEF DESCRIPTION OF THE DRAWING

The above and other objects, features, and advantages will become more readily apparent from the following description, reference being made to the accompanying drawing in which:

FIG. 1 is a side sectional view of a machining apparatus according to the invention;

FIG. 2 is a longitudinal section through a portion of the apparatus of FIG. 1; and

FIG. 3 is a view like FIG. 1 of a variant on the system of this invention.

### SPECIFIC DESCRIPTION

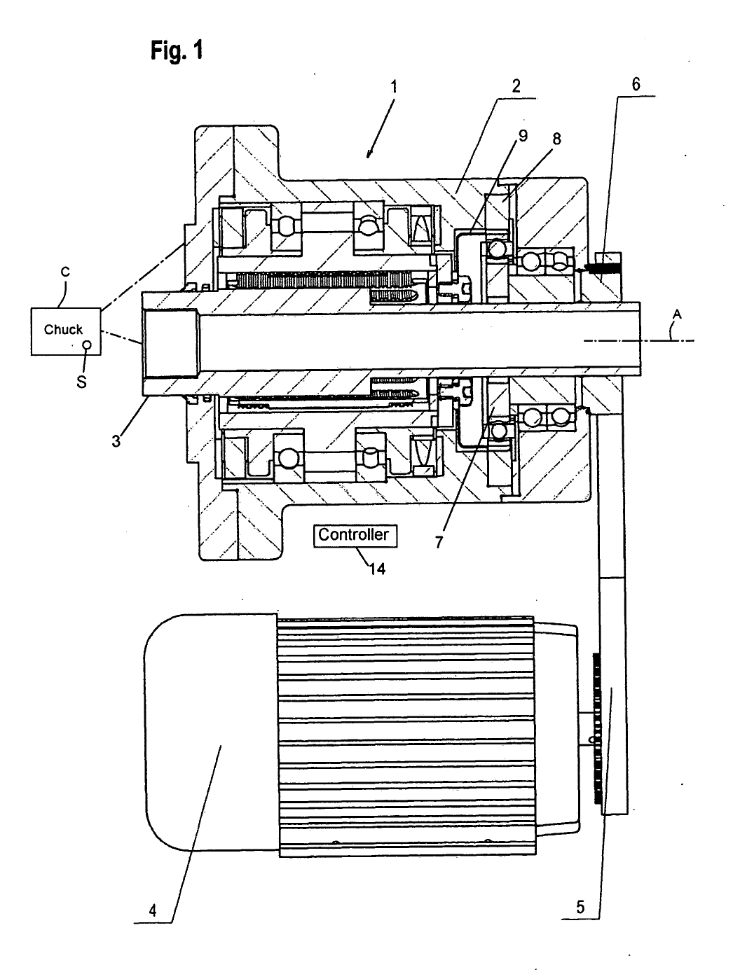

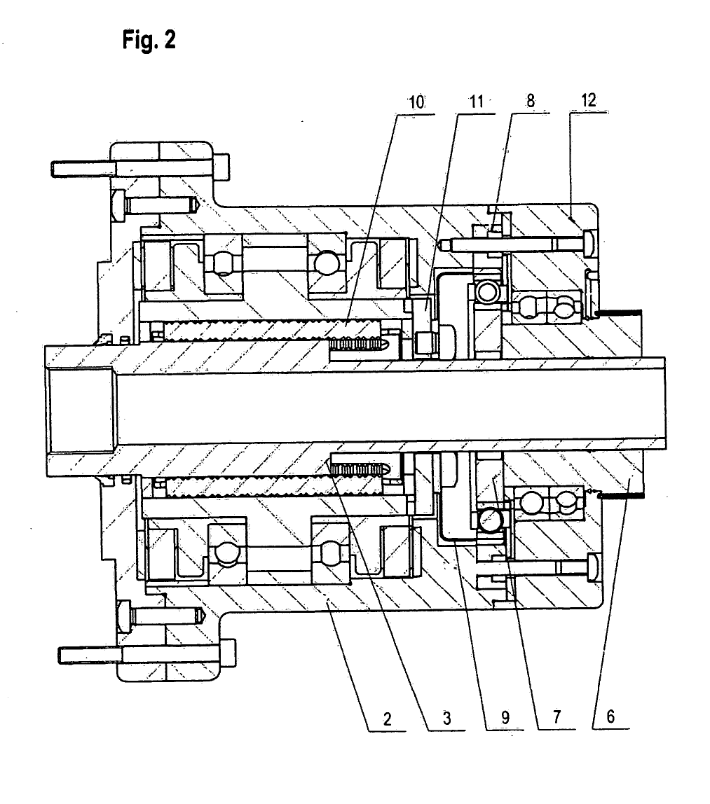

As seen in FIGS. 1 and 2 a chuck actuator 1 is used to displace the jaws of a chuck C attached to the actuator 1 and also at high speeds of the chuck during the clamping process to displace them with certainty for a prolonged period with respect to the workpiece or the tool gripped by the chuck C. To this end, the electric actuator 1 is provided with a housing 2 that is attached to the working spindle of the actuator and in which a threaded rod 3 is displaceable along an axis A for displacing jaws of the chuck C. The actuator moreover includes an electric motor 4 that is mounted next to the housing 2 and that is connected via a belt drive 5 to a drive wheel 6 that is driven by the rotor of the motor 4. The actuator 1 moreover includes a controller 14 that changes the effect on the displacement of the chuck's jaws via the threaded rod 3 as a function of the instantaneous speed of the chuck C. Thus the desired range of clamping force is assured over a broad range of speeds.

The drive wheel 6 is connected to a wave generator 7 of a harmonic drive whose ring gear 8 is connected to the housing 2 and whose flexspline 9 has external teeth driving the threaded rod 3. In this manner it is possible to better change the effect on the displacement of the jaws as a function of the instantaneous speed of the chuck. In the embodiment shown in the drawing, the flexspline 9 is provided as the drive for the threaded rod 6 via a roller screw drive 10 that can also be configured as a ball screw drive or as a spindle nut. The externally toothed flexspline 9 is connected to the roller screw drive 10 via a claw clutch 11 that has some play.

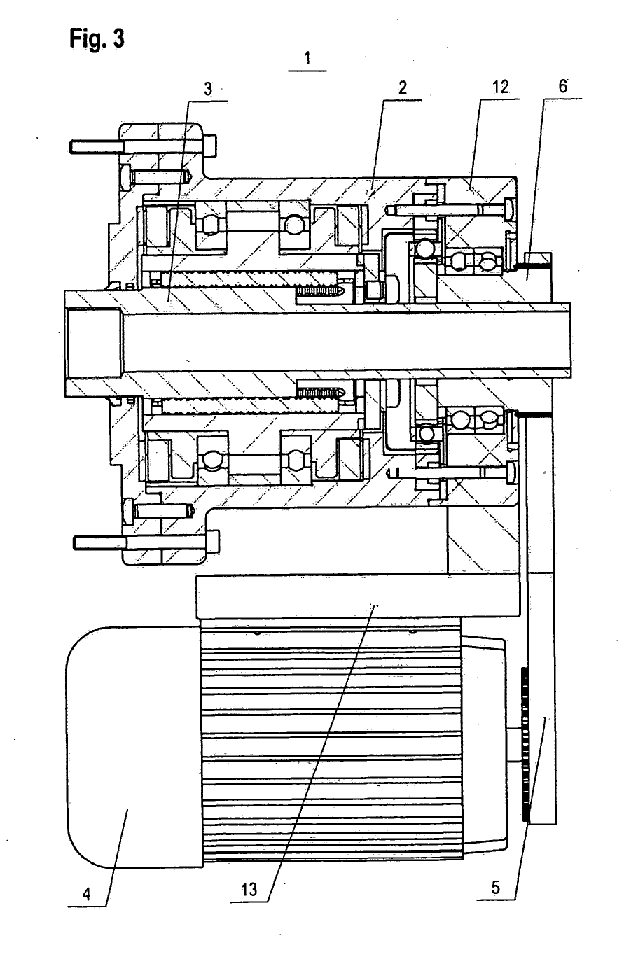

FIG. 3 shows an embodiment in which a cover 12 of the housing 2 is attached to a frame 13 of the machining apparatus such that support of the working spindle is not negatively impacted by the presence of the positioning motor 4 also fixed to the frame 13.

The actuator preferably contains at least one strain-gauge sensor S that is mounted on at least one jaw of the chuck C. The sensor S is configured for measuring the effective centrifugal force-dependent clamping force. This sensor S can output a signal that is directly related to rotation speed or to net clamping force.

The method for operating the actuator described above includes the step of controlling the effect on the displacement of the jaws of the chuck C via the threaded rod 3 as a function of the instantaneous speed of the chuck. This step of changing the effect with the speed of the chuck may further include the step of selecting from a correlation table at least one correlation value of the effect for the prespecified speed of the chuck and the step of supplying the selected value to the controller 14. The selected value is compared with the instantaneous speed outputted by the sensor S and the force is increased or decreased as needed. When gripping outside the tool or workpiece, the force is increased with increased rotation speed and vice versa, and the opposite is done when gripping inside the tool or workpiece.

When using a sensor that measures net clamping force, this value is compared with the desired clamping force to make the necessary correction.

The correlation table preferably has at least a first subtable for use when the chuck speed is increasing and at least a second subtable for when the chuck speed is decreasing. Special first subtables and second subtables may be provided for different clamping diameters and/or materials to be machined. These subtables are stored in a memory of the controller 14. Before the start of the machining operation the operator enters various data—inside or outside chucking, workpiece material, workpiece diameter—so that the right subtable is used with the instantaneous-speed output from the sensor S.

In the correlation table, the correlation values for the effect may be determined for a speed interval of 500 rpm for a range of speeds from 0 to 10,000 rpm. Moreover, in the method for operating an actuator, the correlation values may be determined for a speed interval of 100 rpm, preferably 20 rpm, and in particular 10 rpm, and for a range of speeds from 0 to 8,000 rpm, preferably 0 to 5,000 rpm, and in particular 0 to 3600 rpm.

The method for operating a chuck actuator advantageously includes a method step of determining an effective centrifugal force-dependent clamping force by means of the sensor S and a method step of regulating the effect on the displacement of the jaws via the threaded rod 3 as a function of the sensor data.

In the method for operating a chuck actuator, preferably the initial value of the clamping force is adjusted to the required clamping force increased by the regulating interval.

In one determination method for a correlation table for centrifugal force compensation in a chuck actuator according to one embodiment of the present invention, a correlation value for the effect on the displacement of the jaws, via the threaded rod 3, as a function of the instantaneous speed of the chuck is determined such that the influence of the centrifugal force on the clamping force for this speed may be reduced.

The present invention also relates to retrofitting a chuck actuator that has an electric actuator 1 to create an inventive actuator having a corresponding controller 14 that changes the effect on the displacement of the jaws, via the threaded rod 3, as a function of the instantaneous speed of the chuck.

I claim:

1. In combination with a chuck rotatable about an axis, an actuator system comprising:
a housing rotatable about the axis and connected to the chuck;
a threaded rod in the housing, extending along the axis, connected to the jaws, and axially displceable to radially shift the jaws;
an electric motor;
a drive wheel rotatable about the axis on the housing and driven by the motor;
a harmonic drive having
a wave generator rotationally fixed to the drive wheel,
a flexspline surrounding the wave generator and having external teeth, and
a ring gear fixed on the housing meshing with the ring gear, and normally rotating jointly with the threaded shaft;
a threaded connection between the flexspline and the threaded rod;
sensor means on the chuck for sensing an instantaneous rotation speed of the chuck; and
control means connected between the sensor means and the electric motor for axially shifting the chuck in accordance with the sensed rotation speed.

2. The chuck actuator defined in claim 1 wherein the threaded connection axially shifts the rod on rotation of the wave generator.

3. The chuck actuator defined in claim 1 wherein the chuck has a jaw and the sensor is in the jaw.

4. A method of operating a machining apparatus having:
a chuck;
a housing rotatable about the axis and connected to the chuck;
a threaded rod in the housing, extending along the axis, connected to the jaws, and axially displceable to radially shift the jaws;
an electric motor;
a drive wheel rotatable about the axis on the housing and driven by the motor;
a harmonic drive having
a wave generator rotationally fixed to the drive wheel,
a flexspline surrounding the wave generator and having external teeth, and
a ring gear fixed on the housing meshing with the ring gear, and normally rotating jointly with the threaded shaft; and
a threaded connection between the flexspline and the threaded rod,
the method comprising the steps of:
detecting an instantaneous rotation speed of the chuck and generating an output corresponding thereto; and
operating the motor to vary a clamping force applied by the chuck to a tool or workpiece in accordance with the instantaneous rotation speed.

5. The method defined in claim 4 wherein, with outside chucking of the tool or workpiece, the clamping force is increased as instantaneous rotation speed increases.

6. The method defined in claim 4, further comprising the steps of:
selecting from a correlation table at least one correlation value of the effect for the speed of the chuck and
supplying the selected correlation value of the effect to a controller for the actuator.

7. The method defined in claim 6 wherein the correlation table has at least a first subtable for use when increasing the speed of the chuck and at least a second subtable for use when reducing the speed of the chuck.

8. The method defined in claim 7 wherein there are sets of first and second subtables for different clamping diameters or workpiece materials.

9. The method defined in claim 6 wherein the correlation table has correlation values for the effect for a speed interval of 500 rpm for a range of speeds of 0 to 10,000 rpm.

10. The method defined in claim 9 wherein for the correlation values the speed interval is at most 100 rpm and the range of speeds is 0 to 8000 rpm.
